(19) United States
(12) Patent Application Publication
(10) Pub. No.: US 2007/0263407 A1
(43) Pub. Date: Nov. 15, 2007

(54) LIGHTING SYSTEM, LIQUID CRYSTAL DISPLAY DEVICE, AND ELECTRONIC APPARATUS

(75) Inventor: Toyohiro SAKAI, Nagano-ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: EPSON IMAGING DEVICES CORPORATION, Nagano (JP)

(21) Appl. No.: 11/736,737

(22) Filed: Apr. 18, 2007

(30) Foreign Application Priority Data
May 15, 2006 (JP) 2006-135660
Feb. 2, 2007 (JP) 2007-023803

(51) Int. Cl. F21V 7/04

(52) U.S. Cl. 362/608

(57) ABSTRACT

A lighting system includes a light source, a light source substrate on which the light source is mounted, and a light guide plate having an end surface. Part of the end surface serves as a light entrance surface that faces the light source. The end surface of the light guide plate has a recession and the inner surface of the recession serves as the light entrance surface. The light source is arranged in the recession such that the light source is not in contact with the light entrance surface.

The entire disclosure of Japanese Patent Application Nos. 2006-135660, filed May 15, 2006 and 2007-023803, filed Feb. 2, 2007 are expressly incorporated by reference herein.

### BACKGROUND

1. Technical Field

The present invention relates to a lighting system, a liquid crystal display device, and an electronic apparatus, and in particular, relates to the structure of a lighting system having a light source and a light guide plate, the structure enabling relative positioning between the light source and the light guide plate.

2. Related Art

Generally known lighting systems have a structure in which light emitted from a light source, such as an LED, is allowed to enter a light entrance surface constituted by part of an end surface of a light guide plate, the light is transmitted through the light guide plate, and the transmitted light is output from a light exit surface of the light guide plate. Those lighting systems are used as surface lighting systems, such as backlights, for illuminating a liquid crystal display panel.

In the above-described lighting system, the luminance distribution of illumination light on the light exit surface of the light guide plate depends on spacing between the light source and the light entrance surface of the light guide plate. Accordingly, a light source substrate mounting the light source and the light guide plate are anchored to a holding frame made of, for example, synthetic resin to fix the spacing between the light source and the light entrance surface of the light guide plate. With this structure, however, since the light source and the light guide plate are positioned through the holding frame, the spacing therebetween fluctuates even when any component has a dimensional error. Unfortunately, this leads to a variation in the luminance of the light guide plate or the luminance distribution thereof.

JP-A-2004-55454 discloses a first example of the known lighting systems. In this system, a light source is in contact with the light entrance surface of a light guide plate to reduce a variation in the luminance of the light guide plate and that in the luminance distribution thereof. JP-A-2006-13087 discloses a second example of the known lighting systems. In this system, a spacer is disposed between a light source substrate and a light guide plate and the light guide plate is positioned by urging the plate against the spacer.

Disadvantageously, in the lighting system of the first example in which the light source is in contact with the light entrance surface, when a physical shock is applied to the system, the light source and the light guide plate may be mechanically damaged. In addition, the light guide plate may be deteriorated by heat generated from the light source. Particularly, regarding a lighting system mounted on an apparatus, such as an in-car apparatus, used in an environment relatively subject to physical shocks, when the lighting system has a structure in which a light source may be brought into contact with a light guide plate, a load is accumulated in the light source (LED), as observed in a vibration test assuming that the system is mounted on an in-car apparatus. Unfortunately, a solder crack may occur in a mounting portion, causing defective illumination.

In the lighting system of the second example in which the spacer provides spacing between the light source and the light guide plate, the spacing therebetween may fluctuate due to a dimensional error of the spacer. Disadvantageously, the fluctuation of the spacing cannot be reduced to the extent expected. In order to ensure the spacing therebetween, the spacer needs to have a complicated shape which avoids the light source and provides many contact portions. This leads to an increase in manufacturing cost. Unfortunately, it is difficult to reduce the size of the lighting system because the spacer having the complicated shape is incorporated in the system.

### SUMMARY

An advantage of some aspects of the invention is to provide a compact lighting system with a simple structure and a low manufacturing cost, the system being capable of reliably maintaining spacing between a light source and a light guide plate with high accuracy.

According to an aspect of the invention, a lighting system includes a light source, a light source substrate on which the light source is mounted, a light guide plate having an end surface, part of the end surface serving as a light entrance surface that faces the light source. The end surface of the light guide plate has a recession and the inner surface of the recession serves as the light entrance surface. The light source is arranged in the recession such that a gap is formed between the light source and the light entrance surface. The light source has a light emitting surface. The light source is mounted on the light source substrate such that the other surface of the light source opposite to the light emitting surface faces a mounting surface of the substrate. Light emitted from the light source enters the light entrance surface of the light guide plate and comes out from a light exit surface, serving as a surface of the light guide plate. In the light guide plate, the end surface having the recession further includes flat portions adjacent to the recession. The mounting surface of the light source substrate is directly in contact with the flat portions. When the end surface of the light guide plate has a plurality of recessions such that a flat portion is arranged between the adjacent recessions, it is preferred that the recessions be arranged at a predetermined pitch such that the flat portions have the same length. Alternatively, the recessions and the flat portions may be symmetrically arranged about the axis of the light guide plate perpendicular to the mounting surface of the light source substrate.

According to this aspect of the invention, the light guide plate has the recession whose inner surface serves as the light entrance surface. Part other than the recession of the end surface is directly in contact with the mounting surface of the light source substrate. In this state, the light source is arranged in the recession such that the light source is not in contact with the light entrance surface. Since the light guide plate and the light source are directly positioned relative to the light source substrate, this lighting system is hardly affected by an error in shape of a component as compared with known systems. Advantageously, the spacing between the light source and the light guide plate can be determined with high accuracy, thus reducing a variation in the luminance of the light exit surface and a variation in the luminance distribution thereof. In addition, since the recession provides a gap between the light source and the light entrance surface, there is no problem caused by bringing the light source into contact with the light entrance surface. Furthermore, since the light guide plate is positioned by bringing the plate into contact with the light source substrate, a spacer is not necessary, thus providing a simple structure of the lighting system. Advantageously, the size and the manufacturing cost of the lighting system can be reduced. In addition, since the mounting surface of the light source substrate is held by the flat portions adjacent to the recession, pressure caused by urging the light guide plate against the light source substrate is distributed by the flat portions. Thus, the light source substrate can be prevented from deforming. Consequently, the gap between the light source and the light guide plate can be stably assured, thus allowing light to be evenly incident on the light guide plate. When a plurality of recessions are arranged such that a flat portion is provided between the adjacent recessions, the light source substrate and the light guide plate can be held more stably. The recessions are arranged at a predetermined pitch such that the flat portions have the same length, so that pressure is evenly applied to the light source substrate. Thus, the light source substrate can be prevented from unevenly deforming. When the recessions and the flat portions are arranged symmetrically about the axis of the light guide plate perpendicular to the light source substrate, the light source substrate can also be prevented from unevenly deforming.

Preferably, the light source is arranged in the recession of the light guide plate such that the light guide plate is not in contact with a soldering portion (joint portion) for mounting the light source. In this case, since the soldering portion is not in contact with the light guide plate (i.e., the end surface thereof), the light guide plate can be positioned with higher accuracy and a mounting portion can be prevented from being damaged upon application of vibration.

According to this aspect of the invention, it is preferable that the lighting system further include an urging member that urges the light guide plate toward the light source, the urging member being arranged so as to face the light source with the light guide plate therebetween. In this case, the urging member urges the light guide plate against the light source substrate, so that the light guide plate can be reliably held in contact with the light source substrate. Since the urging member is arranged so as to face the light source with the light guide plate therebetween, the urging member can be simply constructed and stable contact between the light guide plate and the light source substrate can be realized.

According to this aspect of the invention, preferably, the lighting system further includes a holding frame that holds the light source substrate and the light guide plate and the urging member includes an elastic member arranged on the side opposite to the light source in the holding frame. Specifically, the urging member may include an elastically deformable frame segment constituting the holding frame. Since the urging member includes the elastic frame segment constituting the holding frame, the lighting system can be constructed without increasing the number of components. Advantageously, the system can be easily miniaturized.

In this aspect of the invention, preferably, the lighting system further includes a holding frame that holds the light source substrate and the light guide plate and the urging member includes an elastic member arranged between the holding frame and the light guide plate. In this case, since the elastic member is arranged between the holding frame and the light guide plate, the urging member can be easily constructed. Thus, an increase in manufacturing cost can be prevented.

In this aspect of the invention, preferably, the lighting system further includes a sheet member arranged under the light guide plate and the elastic member includes a bent end portion of the sheet member. In this case, since the elastic member includes the bent end portion of the sheet member arranged under the light guide plate, the lighting system can be constructed without increasing the number of components. Advantageously, the size and the manufacturing cost of the system can be reduced. As the sheet member, a light reflective sheet or a radiating sheet may be used.

In this aspect of the invention, preferably, the lighting system further includes a reflective member arranged in a position corresponding to the recession. Since the light source is not in contact with the light entrance surface of the light guide plate in this system, there is a gap between the light source and the light entrance surface. Accordingly, light may be leaked out from the gap or be absorbed by a chassis, leading to a decrease in light use efficiency. With the above-described arrangement in this aspect of the invention, the reflective member, arranged in the position corresponding to the recession, reflects light emitted form the light source toward the light entrance surface of the light guide plate. Advantageously, light emitted from the light source can be efficiently used. Specifically, the reflective member, e.g., a reflective sheet arranged under the light guide plate, extends so as to cover the recession. Thus, the reflective member having reflective properties can be easily provided. Preferably, a mounting surface of the light source substrate includes a light reflecting surface. In this case, since the mounting surface of the light source substrate serves as the light reflecting surface, light coming from the end surface of the light guide plate can be returned to the inside of the light guide plate, thus improving the light use efficiency.

According to another aspect of the invention, a liquid crystal display device includes the lighting system according to the foregoing aspect, and a liquid crystal display panel using illumination light emitted from the lighting system as at least part of display light. In this case, since the liquid crystal display panel is illuminated with illumination light in which a variation in luminance and a variation in luminance distribution are reduced, a variation in brightness of display using the illumination light and a variation in display quality using the illumination light can be reduced.

According to further another aspect of the invention, an electronic apparatus includes the liquid crystal display device according to the above-described aspect. The electronic apparatus according to this aspect includes a television receiver, a video monitor, a portable computer, a mobile phone, or an electronic clock. Particularly, it is preferred to apply the invention to an in-car electronic apparatus, e.g., an in-car television receiver, an in-car monitor, or an in-car navigation system.

### BRIEF DESCRIPTION OF THE DRAWINGS

The invention will be described with reference to the accompanying drawings, wherein like numbers reference like elements.

FIG. 1 is a schematic plan view of a lighting system according to an embodiment of the invention.

FIG. 2 is a schematic cross-sectional view of the system taken along the line II-II of FIG. 1.

FIG. 3 is an enlarged longitudinal sectional view of a portion in the vicinity of a light source.

FIG. 4 is a schematic cross-sectional view of a lighting system according to another embodiment of the invention.

FIG. 5 is an exploded perspective view of a liquid crystal display device according to an embodiment of the invention.

FIG. 6 is a schematic perspective view of an electronic apparatus according to an embodiment of the invention.

### DESCRIPTION OF EXEMPLARY EMBODIMENTS

### Lighting System

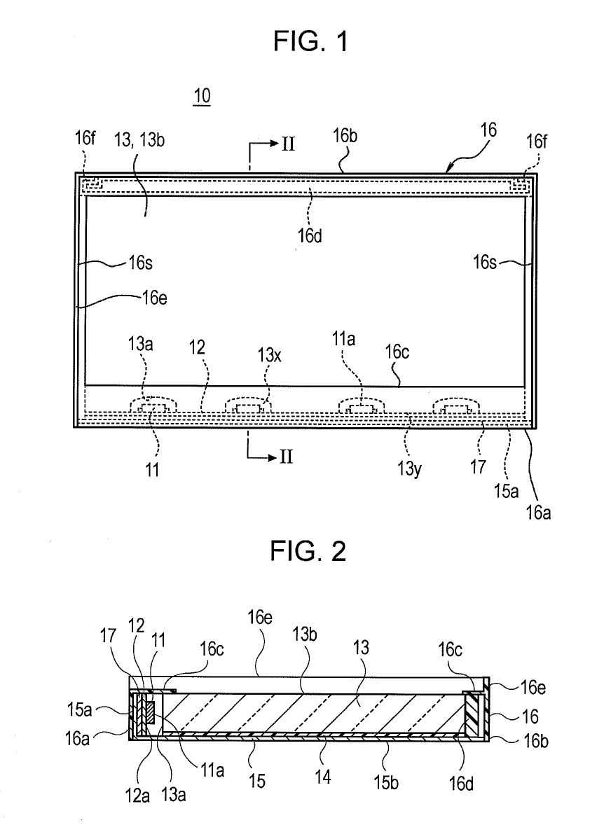

An embodiment of the invention will now be described with reference to the drawings. FIG. 1 is a schematic plan view of the entire structure of a lighting system 10 according to the present embodiment. FIG. 2 is a schematic cross-sectional view of the lighting system 10 taken along the line II-II of FIG. 1. In the drawings, the dimensions of each component, the ratio of length to thickness thereof, and the scale ratios between components are appropriately modified for the sake of convenience and the actual dimensions and ratios are not shown.

The lighting system 10 according to this embodiment includes a plurality of light sources 11, a light source substrate 12 mounting the light sources 11, a light guide plate 13 in contact with the light source substrate 12, and a reflective sheet 14 arranged under the light guide plate 13. Each light source 11 includes a light emitting diode (LED). Referring to FIG. 1, each light source 11 includes a rectangular resin-sealed surface-mount LED chip. The light sources 11 are mounted on the light source substrate 12 by soldering. The light source substrate 12 has a wiring pattern (not shown). Terminals arranged on a mounting surface 12a are connected to the light sources 11. The light sources 11 each have a light emitting surface 11a. Each light source 11 is mounted on the light source substrate 12 such that the surface opposite to the light emitting surface 11a faces the mounting surface 12a. In other words, in this embodiment, the optical axis of each light emitting surface 11a is substantially orthogonal to the mounting surface 12a of the light source substrate 12.

Part of the mounting surface 12a which is not covered with the light sources 11 is overlaid with a reflective layer (not shown), such as a white printing layer or a resin layer. The overlaid part serves as a light reflecting surface. Preferably, the reflective layer is formed by, for example, silk-screen printing. As for a material for the light source substrate 12, various materials are available. Generally, the light source substrate 12 includes a flexible substrate containing a synthetic resin, such as polyimide resin, as a base material. Preferably, a substrate containing a metal, such as aluminum or copper, as a base material is used to prevent an increase in temperature of the light sources 11 caused by heat generated from the light sources 11.

The back surface of the light source substrate 12 (i.e., the rear surface of the mounting surface 12a) is supported by a radiating chassis 15, with a flexible heat conductive member 17 therebetween. The heat conductive member 17 includes, for example, a high thermal conductivity tape or sheet or radiating grease. The light source substrate 12 may be directly in contact with the radiating chassis 15 without using the heat conductive member 17. The radiating chassis 15 includes a bent end portion 15a and a support plate 15b. The bent end portion 15a is arranged at the rear of the light source substrate 12. The support plate 15b is arranged under the reflective sheet 14 overlaid with the light guide plate 13.

The light guide plate 13 includes a transparent material, such as acrylic resin or polycarbonate resin, and has a tabular shape. Referring to FIG. 1, the light guide plate 13 has a rectangular shape when viewed in plan and has four end surfaces. One of those end surfaces has recessions 13x. The inner surface of each recession 13x serves as a light entrance surface 13a which faces the corresponding light source 11. Referring to FIG. 1, the outline of each recession 13x is curved (semi-oval or arcuate) so as to surround the light source 11 when viewed in plan. Similarly, each light entrance surface 13a is a curved surface. The recessions 13x, i.e., the light entrance surfaces 13a correspond to the respective light sources 11. The shape of each light entrance surface 13a is not limited to that shown in the diagram. The light entrance surface 13a may have any shape so long as the light entrance surface 13a permits light emitted from the corresponding light source 11 to enter the light guide plate 13 without any obstruction. For example, the light entrance surface 13a may include an irregular prism surface.

The light guide plate 13 includes a light deflector for deflecting light incident on the light entrance surfaces 13a to a light exit surface 13b, which serves as the top (front) surface of the light guide plate 13. The light deflector is constructed by forming, for example, a prism structure or a printing layer for light scattering on the bottom surface of the light guide plate 13. The light deflector is arranged with an appropriate distribution density (for example, with such a distribution density that the density gradually becomes lower as its location is farther away from the light sources 11) so that the luminance of the light exit surface 13b is made uniform.

In the end surface of the light guide plate 13 which has the recessions 13x, portions 13y other than the recessions 13x are fundamentally flattened. The flat portions 13y are in contact with portions, where the light sources 11 are not mounted, in the mounting surface 12a of the light source substrate 12. The light sources 11 are disposed in the respective recessions 13x such that such that each light source 11 is not in contact with the corresponding light entrance surface 13a. It is preferred that the gap between the light emitting surface 11a of each light source 11 and the light entrance surface 13a be in the range of 0.1 mm to 0.5 mm. If the gap therebetween is less than 0.1 mm, the actual gap therebetween may become short due to a variation in the height of the light source 11 or a variation in the mounted level of the light source 11 on the light source substrate 12. In this case, the light source 11 may be brought into contact with the light entrance surface 13a by vibration. On the other hand, when the gap therebetween exceeds 0.5 mm, the incidence rate of light incident on the light guide plate 13 may be lowered, alternatively, the planar size of the system may be increased.

The reflective sheet 14 is arranged under the light guide plate 13 so as to return light coming from the bottom surface of the light guide plate 13 to the inside of the light guide plate 13. The reflective sheet 14 is made of resin, such as white polyethylene. The reflective sheet 14 extends so as to cover the recessions 13× and reflects light emitted from the light sources 11 to the respective light entrance surfaces 13a of the light guide plate 13.

The light guide plate 13 is fundamentally held in a holding frame 16. The holding frame 16 includes a reflective material, such as white polyethylene, and has a rectangular shape when viewed in plan so as to surround the light guide plate 13. The holding frame 16 includes a first side wall 16a arranged on the outside of the light source substrate 12 (specifically, on the outside of the bent end portion 15a of the radiating chassis 15), a second side wall 16b that is opposite the first side wall 16a, and other side walls 16s connecting the first and second side walls 16a and 16b.

Each of the first, second, and other side walls 16a, 16b, and 16s has a flange segment, the flange segments constituting a flange 16c that inwardly extends so as to overlap the light exit surface 13b of the light guide plate 13. The flange segment of the first side wall 16a has the longest width so as to cover an area in the vicinity of the light entrance surfaces 13a which face the respective light sources 11, thus preventing generation of high luminance spots in the vicinities of the light entrance surfaces 13a in the light exit surface 13b.

Further, an elastic support 16d is arranged on the inside of the second side wall 16b of the holding frame 16. The elastic support 16d is elastically deformed so as to be movable toward the light guide plate 13 relative to the second side wall 16b. The elastic support 16d and the second side wall 16b constitute an elastic frame segment, serving as an urging member for urging the light guide plate 13 toward the light sources 11. The elastic support 16d is connected to the second side wall 16b through thin coupling portions 16f, which are elastically deformable. Elastic deformation of the coupling portions 16f permits the elastic support 16d to be movable in the longitudinal direction in FIG. 1. Therefore, the gap between the first side wall 16a and the elastic support 16d is set such that the distance therebetween is shorter than the total dimension of accommodated components, such as the light guide plate 13, the light source substrate 12, the heat conductive member 17, and the radiating chassis 15, and the difference between the total dimension of the components and the distance therebetween is equal to or less than a distance where the elastic support 16d is movable in the longitudinal direction in FIG. 1. Thus, when the components are accommodated in the holding frame 16, the light guide plate 13 is pressed against the light source substrate 12 by the elastic force of the elastic frame segment.

A rim 16e is arranged in at least part of the holding frame 16 including the first side wall 16a, the second side wall 16b, and the other side walls 16s. Referring to FIG. 1, the rim 16e is arranged in the second side wall 16b and the other side walls 16s such that the rim 16e extends from the bottom of the flange 16c in the direction in which light is emitted. The rim 16e is a structural element for positioning and holding a liquid crystal display panel, which will be described below.

In this embodiment, the light guide plate 13 is pressed toward the light sources by the elastic force of the elastic support 16d in the holding frame 16. The flat portions 13y of the light guide plate 13 are held in contact with the mounting surface 12a of the light source substrate 12. In this state, the light sources 11 are arranged in the respective recessions 13x such that each light source 11 is not in contact with the corresponding light entrance surface 13a. Accordingly, since the light guide plate 13 is directly aligned with the light source substrate 12, the gap between the light emitting surface 11a of each light source 11 and the corresponding light entrance surface 13a is determined by the dimensional accuracy of the light guide plate 13 and the height accuracy of the light source 11 so long as the light source 11 is mounted in contact with the light source substrate 12. Therefore, the influence of a dimensional error of a spacer, which may be caused in the known structure for positioning a light guide plate relative to light sources through the spacer, can be eliminated, thus reducing a variation in the gap between each light source and the light guide plate.

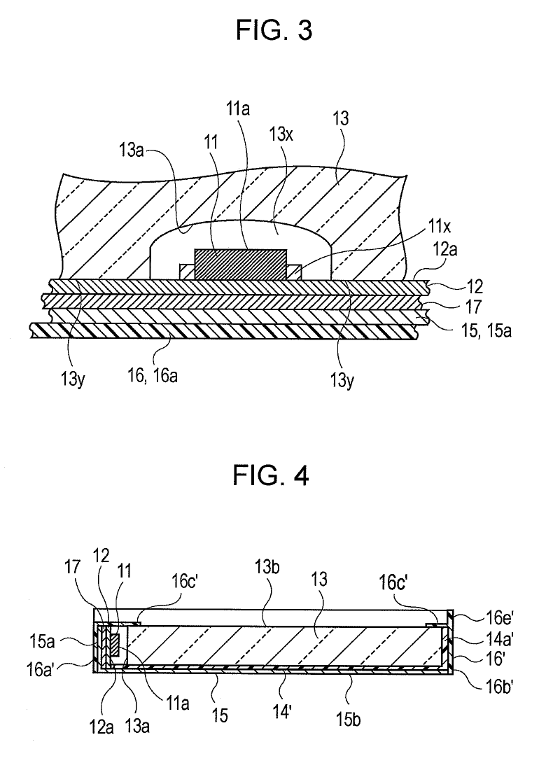

In this embodiment, since the recessions 13x of the light guide plate 13 ensure spaces for accommodating the light sources 11, each light source 11 can be surely prevented from being brought into contact with the corresponding light entrance surface 13a upon application of impact or vibration. Consequently, occurrence of defective mounting of the light sources 11, damage to the light sources 11, and damage to the light guide plate 13 can be prevented. In this case, it is preferred that a soldering portion (joint portion) 11x (refer to FIG. 3) be arranged in each recession 13x such that the portion 11x is not in contact with the light guide plate 13. Each soldering portion 11x serves as a portion for conductive connection between the light source 11 and the light source substrate 12. Consequently, the light guide plate 13 can be positioned with higher accuracy. In addition, this arrangement can prevent defective mounting caused by damage to the soldering portions upon application of vibration.

Furthermore, since the light guide plate 13 is positioned by holding the plate 13 in contact with the light source substrate 12 in this embodiment, it is unnecessary to provide any special component, such as a spacer having a complicated shape. Advantageously, the system can be miniaturized. Particularly, the planar size thereof can be reduced. In addition, an increase in manufacturing cost can be suppressed.

FIG. 3 is an enlarged longitudinal sectional view of a portion in the vicinity of the light source 11 in this embodiment. Since the radiating chassis 15 is close to the back of the light source substrate 12 with the flexible heat conductive member 17 therebetween, the substantial thermal contact area between the light source substrate 12 and the radiating chassis 15 can be increased. Thus, heat generated from the light source substrate 12 can be efficiently transferred to the radiating chassis 15. In addition, since the mounting surface 12a of the light source substrate 12 is directly in contact with the flat portions 13y of the light guide plate 13 as described above, heat generated from the light source substrate 12 is dissipated into the light guide plate 13. Therefore, heat generated from each light source 11 is efficiently dissipated through the light source substrate 12, thus reducing the temperature of the light source 11. Consequently, a variation in the luminance of each light source 11 can be reduced and the progression of deterioration in luminance can be retarded.

In the structure where the plurality of light sources 11 are arranged as shown in FIG. 1, the unevenness of the temperature distribution caused along the arrangement of the light sources 11 can be reduced by improving the heat dissipation characteristics as described above. Accordingly, variations in luminance and chromaticity among the light sources 11 can be reduced. For example, when the light sources 11 are arranged linearly, generally, the temperature of the light source 11 in the middle of the arrangement becomes higher and that at each end of the arrangement becomes lower. The improvement of the heat dissipation characteristics reduces the differences in temperature among the light sources 11 in both ends and the middle of the arrangement, so that the variations in luminance and chromaticity among them are reduced. Particularly, when a red-light emitting device including a red LED, a green-light emitting device including a green LED, and a blue-light emitting device including a blue LED are combined into each light source 11, the temperature dependences of the respective LEDs are remarkably different from one another (for example, although the luminance of the blue LED increases with increasing temperature, that of each of the read and green LEDs decreases with increasing temperature). Accordingly, the differences in environmental temperature among the respective light sources cause remarkable variations in chromaticity among them. In this embodiment, however, since the differences in temperature among the light sources are reduced, the variation in chromaticity among them can also be reduced.

Furthermore, since the light guide plate 13 is urged against the light source substrate 12 by the urging member such that the light guide plate 13 is held in contact with the substrate 12, it is unnecessary to arrange an engagement projection for positioning the light guide plate 13 in the holding frame 16. Advantageously, the holding frame 16 can be reduced in width, that is, the side walls 16s can be thinned. Consequently, the planar size of the lighting system 10 can be reduced and the thickness of the frame (surrounding an illumination area) can be reduced. This invention does not exclude a case where the light guide plate 13 is positioned such that the plate is engaged with the holding frame 16 or the radiating chassis 15. The invention contains this arrangement so long as the light guide plate 13 positioned as described above is urged against the light source substrate 12 such that the flat portions 13y are in contact with the mounting surface 12a of the light source substrate 12.

FIG. 4 is a schematic cross-sectional view of a lighting system according to another embodiment of the invention. In FIG. 4, the same components as those in the foregoing embodiment are designated by the same reference numerals and a description of the previously explained components is omitted. In this embodiment, light sources 11, a light source substrate 12, a light guide plate 13, and a radiating chassis 15 are the same as those of the foregoing embodiment. A holding frame 16′ does not include the above-described elastic frame segment. In other words, the elastic support 16d and the coupling portions 16f are not arranged on the side opposite to the light sources 11 with the light guide plate 13 therebetween. A second side wall 16b′ corresponding to the above-described second side wall 16b is arranged on this side.

In this embodiment, a reflective sheet 14′ is arranged under the light guide plate 13. The reflective sheet 14′ has a bent end portion 14a′ which is disposed between the light guide plate 13 and the second side wall 16b′. The reflective sheet 14′ contains the same material as that of the reflective sheet 14 in the foregoing embodiment and has the same optical characteristics as those of the reflective sheet 14. The bent end portion 14a′ exerts a resilient restoring force which acts to reduce the angle of bending defined between the bent end portion 14a′ and the other portion of the reflective sheet 14′. Since the bent end portion 14a′ is arranged between the light guide plate 13 and the second side wall 16b′, therefore, the light guide plate 13 is pressed toward the light sources 11 by the resilient force of the bent end portion 14a′ of the reflective sheet 14′, so that the light guide plate 13 is held in contact with the light source substrate 12 in a manner similar to the foregoing embodiment. In this embodiment, the reflective sheet 14′ extends so as to cover recessions 13x, thus reflecting light emitted from the light sources 11 to respective light entrance surfaces 13a of the light guide plate 13.

In this embodiment, the bent end portion 14a′ functions as an elastic member compressed and arranged between the light guide plate 13 and the second side wall 16b′. Accordingly, any elastic member, such as rubber or a spring, may be arranged between the light guide plate 13 and the holding frame 16′ instead of the bent end portion 14a′ of the reflective sheet 14′ so that the light guide plate 13 is urged against the light source substrate 12 by the resilient force of the elastic member.

In FIG. 4, the bent end portion 14a′ is disposed between the light guide plate 13 and the second side wall 16b′ of the holding frame 16′ and the radiating chassis 15 includes a bent end portion 15a at one end thereof. For example, the radiating chassis 15 may further include another bent end portion at the other end thereof. The bent end portion 14a′ may be disposed between the other bent end portion of the radiating chassis 15 and the light guide plate 13.

In this embodiment, the bent end portion 14a′ of the reflective sheet 14′ is used as an elastic member. The elastic member is not limited to the reflective sheet 14′. For example, the radiating chassis 15 may further include another bent end portion and this bend end portion may be arranged between the light guide plate 13 and the second side wall 16b′ of the holding frame 16′ instead of the bent end portion 14a′ of the reflective sheet 14′. In other words, a sheet member of the invention is not specifically limited. Any member may be used so long as the member is arranged under the light guide plate 13 and a bend end portion at one end of the member exerts a resilient restoring force acting in the direction opposite to the bending direction so as to function as an elastic member for urging the light guide plate 13.

### Liquid Crystal Display Device

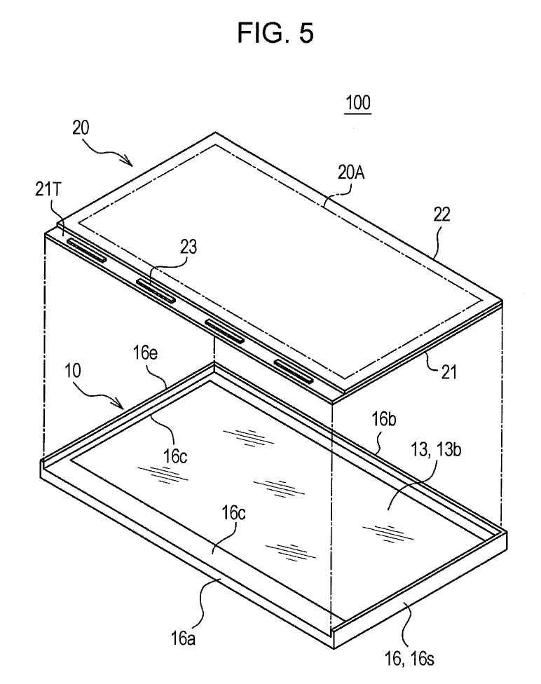

A liquid crystal display device according to an embodiment of the invention will now be described with reference to FIG. 5. A liquid crystal display device 100 includes the foregoing lighting system 10 and a liquid crystal display panel 20 utilizing illumination light emitted from the light exit surface 13b of the lighting system 10. Referring to FIG. 5, the liquid crystal display panel 20 is superimposed on the front surface of the lighting system 10. The liquid crystal display panel 20 utilizes at least part of the illumination light emitted from the lighting system 10 as display light.

The liquid crystal display panel 20 is constructed by joining transparent substrates 21 and 22, made of glass or plastic, through a sealing member (not shown) and filling a space defining the sealing member between the substrates with liquid crystal (not shown). Since the lighting system 10 is used as a backlight as described above, the liquid crystal display panel 20 is a transmissive or transflective type. Lines and electrodes are appropriately arranged on inner surfaces of the respective substrates 21 and 22 and pixels, each of which is formed between the electrodes facing each other with the liquid crystal therebetween, are arranged in a matrix, thus providing a display area 20A. The substrate 21 has an extension 21T that extends beyond the substrate 22. The lines (leads), not shown, are arranged on a surface of the extension 21T. An integrated circuit (IC) chip constituting a driving circuit is mounted in each area where the leads are arranged. The IC chips 23 drive the pixels in the display area 20A using proper driving signals on the basis of control signals or data signals externally supplied through the lines, thus controlling the transmittances of the respective pixels.

The liquid crystal display panel 20 is arranged on the inside of the rim 16e of the holding frame 16 such that the extension 21T is disposed on a part of the flange 16c of the holding frame 16, the part covering the light sources 11. With this arrangement, the lighting system 10 and the liquid crystal display panel 20 can be horizontally positioned. Furthermore, the lighting system 10 and the liquid crystal display panel 20 can be integrated with each other using an appropriate fixing member, e.g., a double-faced tape. Since the extension 21T is arranged above the light sources 11, the planar size of the display device can be reduced.

### Electronic Apparatus

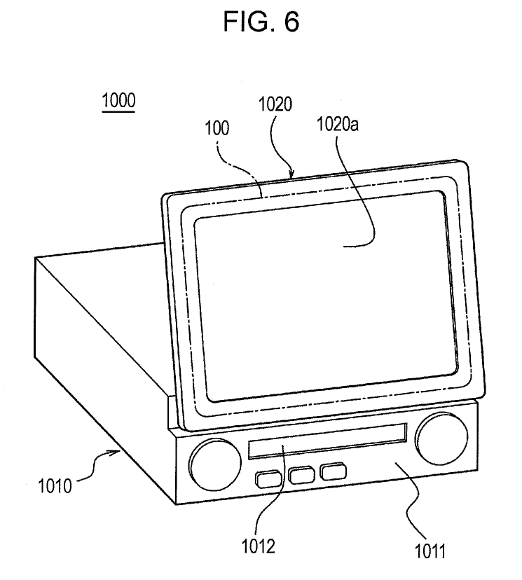

An electronic apparatus according to an embodiment of the present invention will now be described with reference to FIG. 6, the electronic apparatus mounting the above-described liquid crystal display device. FIG. 6 is a schematic perspective view of the electronic apparatus. Referring to FIG. 6, an electronic apparatus 1000 is an in-car navigation system. The electronic apparatus 1000 includes a body 1010 and a display unit 1020 connected to the body 1010. The body 1010 has an operation panel 1011 on which operation buttons are arranged and a slot 1012 through which a recording medium, such as a DVD, is inserted. The display unit 1020 includes the above-described liquid crystal display device 100. Display by the liquid crystal display device 100, i.e., display of a navigation image can be visually confirmed on a display screen 1020a of the display unit 1020.

Since the electronic apparatus 1000 mounts the above-described liquid crystal display device 100, a variation in the luminance of display light emitted from the display screen and a variation in the luminance distribution thereof can be reduced, thus realizing high display quality. Furthermore, this electronic apparatus ensures reliability without problems on the light sources upon application of vibration of a vehicle.

The lighting system, the liquid crystal display device, and the electronic apparatus related to the invention are not limited to those described above with reference to the drawings but many modifications and variations are possible without departing from the spirit or scope of the invention. For example, the above-described lighting system is not limited to that mounted on a liquid crystal display device. The lighting system may be used alone. Alternatively, the lighting system may be incorporated in any device other than a liquid crystal display device.

What is claimed is:

1. A lighting system comprising:
a light source;
a light source substrate on which the light source is mounted; and
a light guide plate having an end surface, part of the end surface serving as a light entrance surface that faces the light source, wherein
the end surface of the light guide plate has a recession and the inner surface of the recession serves as the light entrance surface, and
the light source is arranged in the recession such that a gap is formed between the light source and the light entrance surface.

2. The system according to claim 1, further comprising:
an urging member that urges the light guide plate toward the light source, the urging member being arranged so as to face the light source, with the light guide plate therebetween.

3. The system according to claim 2, further comprising:
a holding frame that holds the light source substrate and the light guide plate, wherein
the urging member includes an elastic member that is arranged on the side opposite to the light source in the holding frame.

4. The system according to claim 2, further comprising:
a holding frame that holds the light source substrate and the light guide plate, wherein
the urging member includes an elastic member arranged between the holding frame and the light guide plate.

5. The system according to claim 4, further comprising:
a sheet member arranged under the light guide plate, wherein
the elastic member includes a bent end portion of the sheet member.

6. The system according to claim 1, further comprising:
a reflective member arranged in a position corresponding to the recession.

7. The system according to claim 6, wherein the reflective member, arranged under the light guide plate, extends so as to cover the recession.

8. The system according to claim 1, wherein a mounting surface of the light source substrate includes a light reflecting surface.

9. A liquid crystal display device comprising:
the lighting system according to claim 1; and
a liquid crystal display panel using illumination light emitted from the lighting system as at least part of display light.

10. An electronic apparatus comprising:
the liquid crystal display device according to claim 9.
